(19) United States
(12) Patent Application Publication
(10) Pub. No.: US 2013/0163635 A1
(43) Pub. Date: Jun. 27, 2013

(54) Foreign object detection in inductive coupled wireless power transfer environment using thermal sensors

(71) Applicants: Avinash Karanth, Chamarajpet (IN); Hari Hara Kumaran Dorairaj, Coimbatore (IN); Rajeev Balakrishnan Reinamma Kumar, Kodichikkanahalli (IN)

(72) Inventors: Avinash Karanth, Chamarajpet (IN); Hari Hara Kumaran Dorairaj, Coimbatore (IN); Rajeev Balakrishnan Reinamma Kumar, Kodichikkanahalli (IN)

(21) Appl. No.: 13/808,786

(22) PCT Filed: Jun. 14, 2011
(86) PCT No.: PCT/EP2011/059839

§ 371 Date: Mar. 14, 2013

(30) Foreign Application Priority Data
Jul. 7, 2010 (IN) 1935/CHE/2010

(51) Int. Cl. G01N 25/00

(52) U.S. Cl. CPC G01N 25/00
USPC 374/45

(57) ABSTRACT

A device for detecting a presence of a foreign object in an inductively coupled power transfer environment, including: a primary unit having a primary coil; a secondary unit having a secondary coil, which is adapted to receive power inductively from the primary coil; a sheet of thermal conductive material adapted to be placed between the primary unit and the secondary unit; at least one temperature sensor to sense the temperature of the sheet; and a control arrangement to control the supply of power to the secondary unit based on a temperature of the sheet measured by the temperature sensors.

### FIELD OF THE INVENTION

The present invention relates to detection of foreign objects in inductively coupled power transfer environments.

### BACKGROUND INFORMATION

Presently, it is understood that many portable battery operated devices are being charged by wireless inductively coupled charging units. These charging units perform battery charging function and also as power supply unit. It has a primary coil which is coupled to a secondary coil in a device being charged by the principle of induction. The transfer of power takes place wirelessly between the primary and the secondary coils.

When a metallic object made of electrically conductive material is inadvertently placed in an inductively coupled power transfer environment, it starts to draw power from the primary coil of the charging unit. This results in power wastage and also heats up the metallic object. If gone unnoticed, the metallic object may become very hot and is safety critical. Thus it is very important to detect presence of any electrically conductive foreign objects to prevent power wastage and avoid the risk of an unsafe environment.

There are a variety of different methods for detecting foreign objects in an inductively coupled wireless power transfer systems. These include detection of foreign object by variation in frequency of the current in the primary coil, detecting imbalanced variations in current and voltages in the primary coil, based on measurements of power drawn from the primary coil and the like.

Patent application WO2009081115 discusses a method for detecting of foreign objects in inductively coupled environments. This application discusses a method wherein the primary coil of the charging unit is driven in different states and corresponding effects of secondary coil and/or a foreign object is determined. These changes are used for detecting presence of foreign object and necessary corrective action is taken.

It is believed that the presently understood methods for detection of foreign object are not very simple in construction and are difficult to implement. Further they may not be very sensitive. There is some delay in detection of the foreign objects after the primary unit is switched on. The foreign object continues to draw power during this period which results in wastage of power. Thus, there is a need for an inductively coupled power transfer system that is simple in construction and easy for implementation. Also it is required that the system has improved sensitivity for detecting foreign objects.

### SUMMARY OF THE INVENTION

The object of the invention is to provide a simple, accurate and sensitive system to detect foreign objects placed in an inductively charged environment. Another object of the invention is to prevent power wastage due to foreign object in the inductively charged environment and avoid risk of unsafe environment.

The apparatus is very simple in construction and does not require any complicated assembly. The apparatus of this invention is very sensitive and can detect the presence of a foreign object soon after the charging is started. This helps in minimizing the wastage of power.

The present invention is described with reference to the following drawing.

### BRIEF DESCRIPTION OF THE DRAWING

FIG. 1 shows a schematic of a device for detecting a foreign object in an inductively coupled charging environment in accordance with this invention.

### DETAILED DESCRIPTION

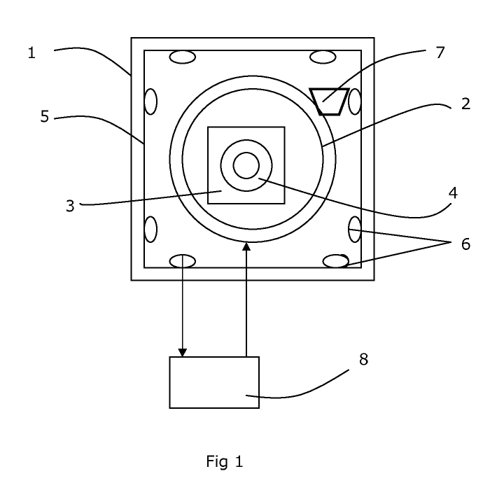

FIG. 1 shows a device for inductive charging, provided with means for detecting a foreign object placed within the inductively coupled charging environment. The device includes a primary unit (1) having a primary coil (2) and a secondary unit (3) having a secondary coil (4). The secondary coil is inductively coupled to the primary coil (2) for charging and power supply applications. The primary unit (1) is provided with a platform on which the secondary unit (3) can be placed. A sheet of thermally conductive and electrically non conductive material (5) is provided on the platform. This sheet (5) is provided with plurality of temperature sensors (6) on its surface to monitor its temperature. A control means (8) is provided to stop the charging of the charged unit (3) by switching off the charging unit (1) based on the temperature monitored by temperature sensors (6). The charging environment is limited by the area of the primary coil covered with thermally conductive and electrically non conductive sheet (5).

When a primary unit (1) is switched on, an inductive field of the primary coil (2) is created around it. The extent of this field is up to the area of the thermal conductive sheet (5). When a secondary unit (3) is placed on the primary unit (1), the secondary coil (4) of the secondary unit (3) gets coupled with the primary coil (2) of the primary unit (1). Transfer of power (3) takes place wirelessly.

When a foreign object (7) is inadvertently placed in the inductively coupled charging environment it starts drawing power from the primary unit (1). The foreign object (7) acts as a parasitic load and the power drawn by it is wasted because it is not utilized for charging or powering of secondary unit (3). This power is dissipated as heat and as a result the temperature of the foreign object (7) starts increasing. As the sheet (5) made of a thermal conductive material is in contact with the foreign object, the temperature of the sheet (5) also starts to increase. The temperature sensors (6) provided in the sheet (5), detect the slightest increase in the temperature of the sheet (5). The controller interprets the increase in temperature of sheet (5) as a result of presence of a foreign object in the wireless power transfer environment. The controller switches off the power to the primary coil (2) and stops the powering the secondary unit (3). This prevents undue wastage of power and avoids the risk of fire due to overheating of the foreign object. The controller may generate an indication to the user to inform the user that a foreign object has been detected in the charging environment and hence the charging unit is switched off. The indication may be an audio beep or a visual indication like an LED or a lamp.

Typically the thermal conductive material used for the sheet (5) is selected from Boron Nitride, Aluminum Nitride, Ceramic coated with Magnesium, Titanium & Composite materials and the like.

1-5. (canceled)

6. A device for detecting a presence of a foreign object in an inductively coupled power transfer environment, comprising:
a primary unit having a primary coil;
a secondary unit having a secondary coil, which is adapted to receive power inductively from the primary coil;
a sheet of thermal conductive material adapted to be placed between the primary unit and the secondary unit;
at least one temperature sensor to sense the temperature of the sheet; and
a control arrangement to control the supply of power to the secondary unit based on a temperature of the sheet measured by the temperature sensors.

7. The device of claim 6, wherein the sheet made of thermal conductive material is electrically non-conductive.

8. The device of claim 6, wherein the thermal conductive material for the sheet is selected from at least one of the following group of materials, including boron nitride, aluminum nitride, ceramic coated with magnesium, titanium and composite materials.

9. The device of claim 6, wherein there are a plurality of temperature sensors displaced over the entire area of the sheet of thermal conductive material.

10. A method for detecting a presence of a foreign object in an inductively coupled power transfer environment, the method comprising:
placing a secondary unit on a primary unit having a thermal conducting sheet;
monitoring a temperature of a thermal conducting sheet by temperature sensors;
detecting a rise in temperature of the thermal conducting sheet;
interpreting a rise in temperature of the thermal conducting sheet as the presence of the foreign object; and
disconnecting a supply of power to the secondary unit by switching off power to the primary coil.
